(19) United States
(12) Patent Application Publication
(10) Pub. No.: US 2014/0197922 A1
(43) Pub. Date: Jul. 17, 2014

(54) SYSTEM AND METHOD FOR POSITIVE IDENTIFICATION ON A MOBILE DEVICE

(71) Applicant: CYGNUS BROADBAND, INC., San Diego, CA (US)

(72) Inventors: Kenneth Stanwood, San Diego, CA (US); David Gell, San Diego, CA (US)

(73) Assignee: CYGNUS BROADBAND, INC., San Diego, CA (US)

(21) Appl. No.: 13/743,149

(22) Filed: Jan. 16, 2013

(51) Int. Cl. G06F 21/32; H04N 5/232

(52) U.S. Cl. CPC G06F 21/32; H04N 5/23219
USPC 340/5.83; 348/333.11

(57) ABSTRACT

A method of capturing a photograph of a user's face with a mobile device includes determining alignment of an image of the user's face with a camera of the mobile device; providing one of a visual indicator and an audible sound as an alignment verification aid which indicates to the user when facial alignment is favorable; and taking a photograph of the user's face when alignment of the user's face with the camera is favorable.

### BACKGROUND

1. Field

The present invention relates to restricting user access to a mobile device and/or electronic content to only authorized users, and more particularly to verifying the identity of an authorized user of a mobile device prior to allowing use of the mobile device or granting access to electronic content such as data and/or applications through the mobile device.

2. Related Art

The popularity and availability of the Internet is causing ever greater expectations of access to functionality and information. However, not all functionality and data is for public access. For instance, a corporation may have specific applications, websites, and data that should only be available to its employees or possibly even to only a small subset of its employees. Hospitals need to restrict access to patient data. Banks may want to verify that the person attempting to access an account is authorized to do so. Applications such as online gambling need to adhere to regulations requiring verification of the identity of users of their services.

Previously, some form of physical security was used to secure this information. Corporations or medical facilities could restrict access to those who were physically on their premises, had access to a corporate issued smartphone or laptop, or had credentials, such as a login or password, to securely access a server through a virtual private network (VPN) or other security facility. Casinos limited gambling to their premises.

Availability of smartphones, such as Apple's iPhone, is causing an increased desire for users to access applications, websites, and data from anywhere and while mobile. Increasingly, corporations are faced with a desire by employees or executives to allow a “bring your own device” (BYOD) policy where the device is used to access both personal and corporate applications and data. Mobile consumer banking, stock market transactions, and other online financial transactions are increasing in popularity and occurrence. Medical practitioners are becoming increasingly mobile while patient privacy regulations are simultaneously becoming more rigorous.

As technology progresses, so do the opportunities for accidental or intentional unauthorized access to devices, applications, websites, and data. Conventional usernames and passwords can be easy to compromise. Devices, such as smartphones and laptops, may be stolen, misplaced, or temporarily ignored. The present disclosure is directed toward overcoming one or more of the problems discovered by the inventors.

### SUMMARY

Embodiments of the present invention provide systems and methods of verifying the identity of a user of a mobile device. According to an aspect of the invention, there is provided a method of capturing a photograph of a user's face with a mobile device. The method of capturing a photograph of a user's face with a mobile device includes determining alignment of an image of the user's face with a camera of the mobile device; providing one of a visual indicator and an audible sound as an alignment verification aid which indicates to the user when facial alignment is favorable; and taking a photograph of the user's face when alignment of the user's face with the camera is favorable.

According to another aspect of the present invention, there is provided a method of method of capturing an image of a user's iris with a mobile device. The method of capturing an image of a user's iris with a mobile device includes determining alignment of an image of the user's eye with a camera of the mobile device; providing one of a visual indicator and an audible sound as an alignment verification aid which indicates to the user when eye alignment is favorable; and capturing an image of the user's iris when alignment of the user's eye with the camera is favorable.

According to yet another aspect of the present invention there is provided a method of granting or denying access. The method of granting or denying access includes capturing an image of a user's face when alignment of the user's face with a camera of a mobile device is favorable; performing facial recognition on the captured image; determining if the user is authenticated as an authorized user based on facial recognition results; when the user is authenticated as an authorized user, permitting access; and when the user is determined to be an unauthorized user, denying access and storing the captured image of the unauthorized user.

According to still another aspect of the present invention, there is provided a method of granting or denying access. The method of granting or denying access includes capturing an image of a user's iris when alignment of the user's eye with a camera of a mobile device is favorable; performing iris recognition on the captured image; determining if the user is authenticated as an authorized user based on iris recognition results; when the user is authenticated as an authorized user, permitting access; and when the user is determined to be an unauthorized user, denying access and storing the captured image of the unauthorized user.

According to still another aspect of the present invention, there is provided a mobile device for performing user identity verification. The mobile device for performing user identity verification includes a display module which displays visual information; a camera module configured to capture and communicate images; and a processor module communicatively coupled to the camera module and the display module.

The processor module receives one or more images of a user captured by the camera module and determines, based on the captured one or more images, whether the captured one or more images correspond to an image of an authorized user, and when the processor module determines the captured one or more images correspond to an image of an authorized user, the processor module permits the user access to one or more of the mobile device, an application available through the mobile device, and data available through the mobile device.

According to still another aspect of the present invention, there is provided a system for performing user identity verification. The system for performing user identity verification includes a display module which displays visual information; a camera module configured to capture and communicate images; a transmitter/receiver module which communicates with a remote server; and a processor module communicatively coupled to the display module, the camera module, and the transmitter/receiver module. The processor module receives one or more images of a user captured by the camera module and derives predetermined metrics from the captured one or more images. Further, the processor module communicates the received one or more captured images or derived metrics to the transmitter/receiver module.

The transmitter/receiver module transmits the one or more captured images or the predetermined metrics derived from the captured one or more images to a remote server. The remote server determines, based on the captured one or more images or predetermined metrics derived from the captured one or more images, whether the captured one or more images or predetermined metrics derived from the captured one or more images correspond to an image of an authorized user or predetermined metrics derived from an image of an authorized user, and transmits a determination result to the transmitter/receiver module.

The transmitter/receiver module communicates the determination result to the processor module, and when the determination result indicates that the captured one or more images or predetermined metrics derived from the captured one or more images correspond to an image of an authorized user or the predetermined metrics derived from an image of an authorized user, the processor module permits the user access to one or more of the mobile device, an application available through the mobile device, and data available through the mobile device.

### BRIEF DESCRIPTION OF THE DRAWINGS

FIG. 1A illustrates a mobile device enabled for performing user identity verification according to an example embodiment of the present invention.

FIG. 1B illustrates a mobile device performing user identity verification via facial recognition according to an example embodiment of the present invention.

FIG. 2A illustrates a mobile device enabled for performing user identification according to an example embodiment of the present invention.

FIG. 2B illustrates a mobile device performing user identity verification via iris recognition according to an example embodiment of the present invention.

FIG. 3 is a block diagram of a device for performing user identity verification according to an example embodiment of the present invention.

FIG. 4 is a block diagram of a network for performing user identity verification according to an example embodiment of the present invention.

FIG. 5 is a flowchart of a method for operating a device to perform user identity verification according to an example embodiment of the present invention.

FIG. 6 is a flowchart of a method for operating a device to perform user identity re-verification and re-authentication according to an example embodiment of the present invention.

### DETAILED DESCRIPTION

While aspects of the present invention are described primarily with respect to a mobile device, one of ordinary skill in the art will appreciate that numerous types of devices or combinations of devices that include a display and forward facing camera, for example, but not limited to, a smartphone, a tablet such as a Blackberry Playbook tablet, a laptop with built-in forward facing camera, or a laptop or other computer with a USB connected camera may be enabled to perform the present invention.

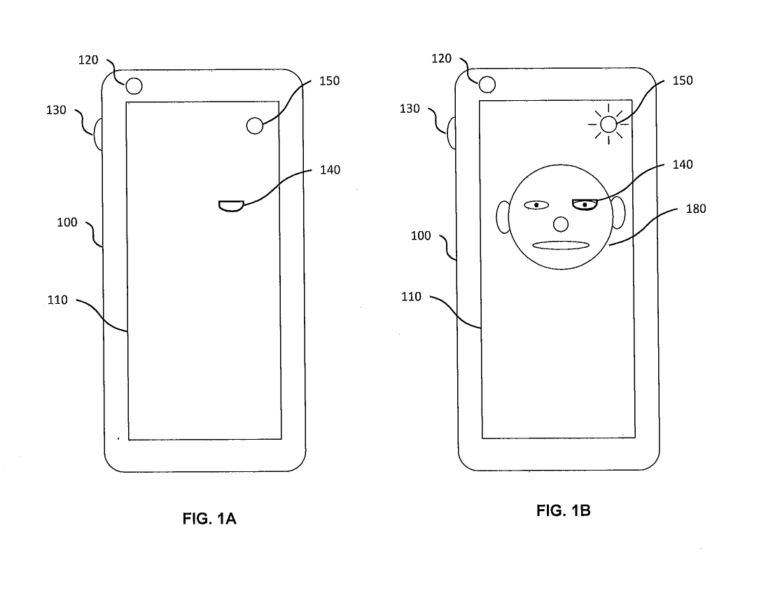

FIG. 1A illustrates a mobile device 100 enabled for performing user identity verification using facial recognition according to an example embodiment. In various example embodiments, the mobile device 100 may be a mobile Worldwide Interoperability for Microwave Access (WiMAX) subscriber station, a Global System for Mobile Communications (GSM) cellular phone, a Universal Mobile Telecommunications System (UMTS) cellular phone, or a Long Term Evolution (LTE) user equipment.

The mobile device 100 has a display screen 110 that can be used to display graphics generated by a processor included in the mobile device 100 and which may also be used to display video or pictures. A forward facing camera 120 may take pictures or video which may be displayed on the display screen 110. A button 130 may be pressed by the user to cause the camera 120 to take a picture; however, the camera 120 may have the ability to take a picture at the direction of the processor or other logic embedded in the mobile device 100. The button 130 may be an electronic switch, a sensor or part of the display.

The mobile device 100 enters identification verification mode when user identification is required. A need for user identification may be triggered by the user attempting to use a phone that requires user authentication prior to use. Alternatively, entry into user identification verification mode may be caused by the user attempting to access a protected application, for example, but not limited to, an application controlled by a private enterprise, either locally on the phone or in the cloud (public or private) on a server to which the phone provides access. These triggers are not mutually exclusive. For example, a user may be required to verify identity to use a phone and subsequently be required to verify identity to access an application or data.

Facial recognition technology may be used for identification verification. There are methods which may aid the reliability of facial recognition. For instance, favorable alignment of the subject in the camera may aid facial recognition. Feedback to the user that alignment is favorable may aid facial recognition. Automatically taking a picture to avoid blurring and loss of favorable alignment that could occur if the user were required to press the button 130 may aid facial recognition.

When the mobile device 100 enters user identity verification mode, it may display an alignment aid 140 on the display screen 110. The mobile device 100 may also display an alignment verification aid 150 on the display screen 110, in a mode indicating initial lack of alignment. In an alternate example embodiment, the alignment verification aid 150 may be a light emitting diode (LED), audible sound, or other indicator separate from the display screen 110.

FIG. 1B illustrates the mobile device 100 performing user identity verification via facial recognition according to an example embodiment. When the mobile device 100 enters user identity verification mode, it activates the forward facing camera 120, causing an image 180 to be displayed on the display screen 110. One skilled in the art would understand that a digital camera as is commonly embedded in mobile devices causes the display screen 110 to act like a viewfinder, actually displaying a moving video of what the camera 120 sees. The alignment aid 140 allows the user to properly orient the mobile device 100, and therefore the camera 120, relative to the user's face or a portion of the user's face. The alignment aid 140 is illustrated in FIGS. 1A and 1B as an area for aligning the user's eye. In an alternative example embodiment, the alignment aid may be two such areas, for aligning both eyes. In another example embodiment, the alignment aid 140 may be a circle, square, or other shape for aligning the user's face instead of the user's eye or eyes.

When the user's face or portion of the user's face is favorably aligned with the alignment aid 140, the alignment verification aid 150 changes state indicating that the user is favorably aligned with the camera 120. One skilled in the art would understand that alignment can be detected using a subset of the technology used for facial recognition. Additionally, when the user's face or portion of the user's face is favorably aligned, the mobile device 100 causes the camera 120 to take a picture of the user's face. The picture, or predetermined metrics derived from the picture, is then compared to a reference picture or pictures, or predetermined metrics, for example, but not limited to, relative position, size, and/or shape of the eyes, nose, cheekbones, and/or jaw, derived from a reference picture or pictures, via facial recognition technology. The facial recognition technology and reference pictures or metrics may be resident either locally on the mobile device 100 or remotely on a server enabled for that purpose.

Other features may also aid in the quality of facial recognition. For instance, Passport Canada requires that passport photos be taken with the person not smiling since not smiling aids in using the passport photos for facial recognition. Certain smartphones, such as the Samsung Infuse 4G and the Sony-Ericsson Experia Arc, have smile detector technology. Such technology can be used with the present invention to aid facial recognition. If the mobile device 100 has smile detector technology, the alignment verification aid 150 may require both favorable positional alignment and detection of no smiling before it changes state, indicating proper alignment and triggering the camera 120 to take the picture. In an example embodiment, the alignment aid 140 may not exist and the alignment verification aid 150 may be used to indicate that the user is not smiling and/or has their eyes open, the detection of which indicates sufficient alignment without an alignment aid.

Additionally, many digital cameras can detect that a photo was taken with the subject's eyes shut, causing them to take an additional photo. This technology can be used to determine whether the user's eyes are open or closed as an input to the alignment decision. The alignment verification aid 150 may require eyes to be open before it changes state, indicating proper alignment and triggering the camera 120 to take the picture. Additionally, a portion of this technology can be used to detect the eyes themselves for positional alignment.

In an example embodiment, identity verification may take a first photo at one alignment and a subsequent photo using a different alignment in order to allow 3-dimensional (3D) facial recognition. In this case, the first alignment aid 140 may be an alignment for a right eye and the nose in profile. A second alignment aid (not shown) may be an alignment for a left eye and the nose in profile. Alignment verification and taking of a photo may occur using both alignment aids. Alternatively, a photo from a 3D camera may be used to capture a 3D image without the need for multiple photos. Alternatively, the camera 120 may take multiple pictures while the user is aligning for a final favorably aligned image.

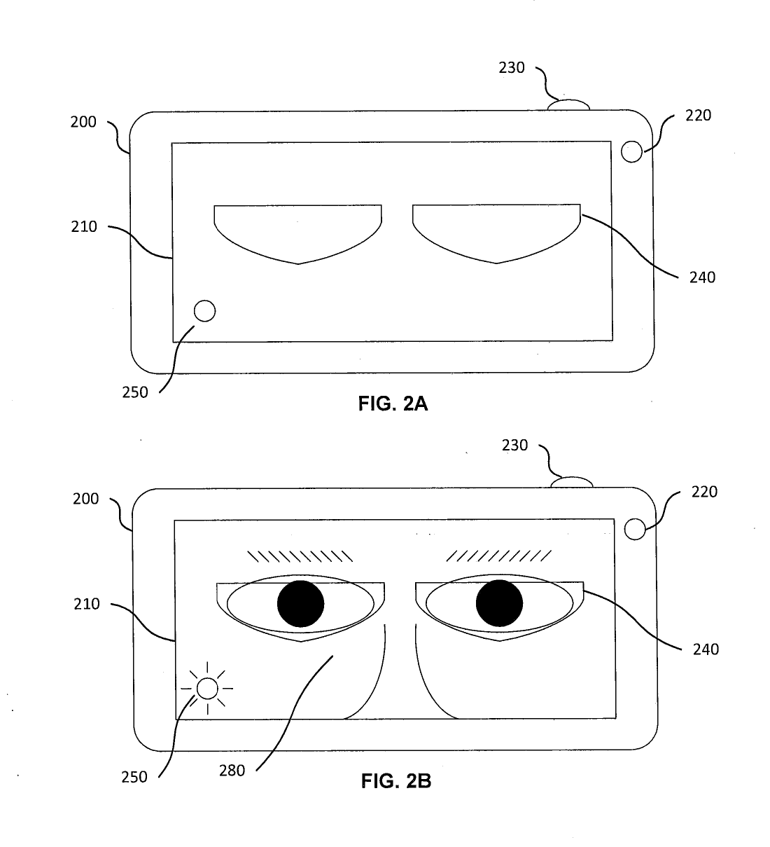

FIG. 2A depicts a smartphone 200 enabled for performing user identification using iris recognition according to an example embodiment. In various example embodiments, mobile device 200 may be a mobile WiMAX subscriber station, a GSM cellular phone, a UMTS cellular phone, or an LTE user equipment. In various example embodiments, the mobile device 100 may be, for example, but not limited to, a smartphone, a personal digital assistant (PDA), a tablet computer, or the like.

The mobile device 200 has a display screen 210 that can be used to display graphics generated by a processor inside the mobile device 200 and which may also be used to display video or pictures. A forward facing camera 220 may take pictures or video which may be displayed on the display screen 210. A button 230 may be pressed by the user to cause the camera 220 to take a picture; however, the camera 220 may have the ability to take a picture at the direction of the processor or other logic embedded in the mobile device 200.

The mobile device 200 enters identification verification mode when user identification is required. A need for user identification may be triggered by the user attempting to use a phone that requires user authentication prior to use. Alternatively, entry into user identification verification mode may be caused by the user attempting to access a protected application, for example, but not limited to, an application controlled by a private enterprise, either locally on the phone or in the cloud (public or private) on a server to which the phone provides access. These triggers are not mutually exclusive. For example, a user may be required to verify identity to use a phone and subsequently be required to verify identity to access an application or data.

Iris recognition technology may be used for identification verification. There are methods which may aid the reliability of iris recognition. For instance, favorable alignment of the subject's eyes in the camera may aid iris recognition. Feedback to the user that alignment is favorable may aid iris recognition. Automatically, taking a picture to avoid blurring and loss of favorable alignment that could occur if the user were required to press the button 230 may aid iris recognition.

When the mobile device 200 enters user identity verification mode, it may display an alignment aid 240 on the display screen 210. The mobile device 200 may also display an alignment verification aid 250 on the display screen 210, in a mode indicating initial lack of facial alignment with the camera 220. In an alternate example embodiment, the alignment verification aid 250 may be an LED, audible sound, or other indicator separate from the display screen 210.

FIG. 2B illustrates the mobile device 200 performing user identity verification via iris recognition according to an example embodiment. When the mobile device 200 enters user identity verification mode, it activates the forward facing camera 220, causing an image 280 to be displayed on the display screen 210. One skilled in the art would understand that a digital camera as is commonly embedded in mobile devices causes the display screen 210 to act like a viewfinder, actually displaying a moving video of what the camera 220 sees. The alignment aid 240 allows the user to properly orient the mobile device 200, and therefore the camera 220, relative to the user's eyes. The alignment aid 240 is depicted in FIGS. 2A and 2B as an area for aligning both of the user's eyes. In an alternative embodiment, the alignment aid may only require aligning one eye.

When the user's face or portion of the user's face is favorably aligned with the alignment aid 240, the alignment verification aid 250 changes state indicating that the user is favorably aligned with the camera 220. One skilled in the art would understand that alignment can be detected using a subset of the technology used for facial recognition. Additionally, when the user's eyes are favorably aligned, the mobile device 200 causes the camera 220 to take a picture of the user's iris or both irises. The picture, or predetermined metrics derived from the picture, is then compared to a reference picture or pictures, or predetermined metrics derived from a reference picture or pictures, via iris recognition technology, for example, but not limited to, iris shape and pattern/texture expressed as phase characteristics. The phase characteristics of an iris may be represented as 256 bytes of data using a polar coordinate system, for example, but not limited to, IrisCode®. The iris recognition technology and reference pictures or metrics may be resident either locally on the mobile device 200 or remotely on a server enabled for that purpose.

Other features may also aid in the quality of iris recognition. For example, many digital cameras can detect that a photo was taken with the subject's eyes shut, causing them to take an additional photo. This technology can be used to provide input as to whether the user's eyes are open or closed to the logic that detects alignment. The alignment verification aid 250 may require eyes to be open before it changes state, indicating proper alignment and triggering the camera 220 to take the picture. Additionally, this technology can be used to detect the eyes themselves for geometric alignment.

One skilled in the art would understand how the above methods could be implemented on a computer or other device with an attached or integrated camera.

One skilled in the art would understand that the above methods may be used to limit access to a device, application or data to a single user, or may alternatively be used to authenticate whether a user is member of a group of users that have access to a shared device, application, or data. These scenarios may be intermixed. For instance a user may be the only allowed user of a dedicated device, but may use that device to access data shared by a group of authorized users.

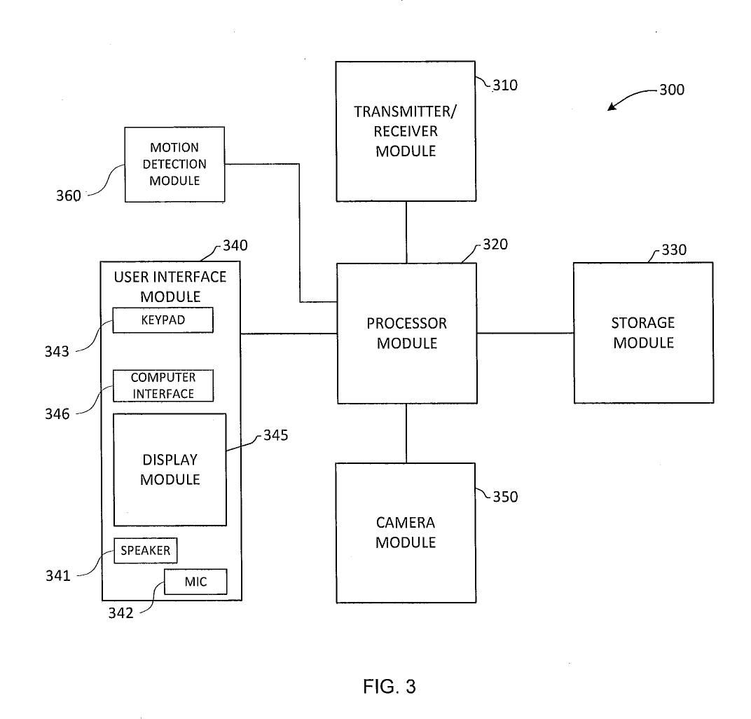

FIG. 3 is a functional block diagram of a mobile device 300 for performing user identity verification according to an example embodiment. In various example embodiments, the mobile device 300 may be, for example, but not limited to, a smartphone, a laptop or computer with an integrated or attached camera, or the like. The mobile device 300 includes a processor module 320. The processor module 320 is communicatively coupled to a transmitter-receiver module (transceiver) 310, a user interface module 340, a storage module 330, and a camera module 350. The processor module 320 may be a single processor, multiple processors, or a combination of one or more processors and additional logic such as application-specific integrated circuits (ASIC) or field programmable gate arrays (FPGA).

The transmitter-receiver module 310 is configured to transmit and receive communications with other devices. For example, the transmitter-receiver module 310 may communicate with a cellular or broadband base station such as an LTE evolved node B (eNodeB) or WiFi access point (AP). In example embodiments where the communications are wireless, the mobile device 300 generally includes one or more antennae for transmission and reception of radio signals. In other example embodiments, the communications may be transmitted and received over physical connections such as wires or optical cables and the transmitter/receiver module 310 may be and an Ethernet adapter or cable modem. Although the mobile device 300 of FIG. 3 is shown with a single transmitter-receiver module 310, other example embodiments of the mobile device 300 may include multiple transmitter-receiver modules. The multiple transmitter-receiver modules may operate according to different protocols.

The mobile device 300, in some example embodiments, provides data to and receives data from a person (user). Accordingly, the mobile device 300 includes a user interface module 340. The user interface module 340 includes modules for communicating with a person. The user interface module 340, in an exemplary embodiment, may include a speaker 341 and a microphone 342 for voice communications with the user, a display module 345 for providing visual information to the user, and a keypad 343 for accepting alphanumeric commands and data from the user. In some example embodiments, the display module 345 may include a touch screen which may be used in place of or in combination with the keypad 343. The touch screen may allow graphical selection of inputs in addition to alphanumeric inputs.

In an alternative example embodiment, the user interface module 340 may include a computer interface 346, for example, but not limited to, a universal serial bus (USB) interface, to interface the mobile device 300 to a computer. For example, the device 300 may be in the form of a dongle that can be connected to a notebook computer via the user interface module 340. The combination of computer and dongle may also be considered a device 300. The user interface module 340 may have other configurations and include functions such as vibrators and lights.

The processor module 320 can process communications received and transmitted by the mobile device 300. The processor module 320 can also process inputs from and outputs to the user interface module 340 and the camera module 350. The storage module 330 may store data for use by the processor module 320, including images or metrics derived from images. The storage module 330 may also be used to store computer readable instructions for execution by the processor module 320. The computer readable instructions can be used by the mobile device 300 for accomplishing the various functions of the mobile device 300.

The storage module 330 may also be used to store photos, such as those taken by camera module 350. In an example embodiment, the storage module 330 or parts of the storage module 330 may be considered a non-transitory machine readable medium. In an example embodiment, storage module 330 may include a subscriber identity module (SIM) or machine identity module (MIM).

For concise explanation, the mobile device 300 or example embodiments of it are described as having certain functionality. It will be appreciated that in some example embodiments, this functionality is accomplished by the processor module 320 in conjunction with the storage module 330, the transmitter-receiver module 310, the camera module 350, and the user interface module 340. Furthermore, in addition to executing instructions, the processor module 320 may include specific purpose hardware to accomplish some functions.

The camera module 350 can capture video and still photos as is common with a digital camera. The camera module 350 can display the video and still photos on the display module 345. The user interface module 340 may include a button which can be pushed to cause the camera module 350 to take a photo. Alternatively, if the display module 345 comprises a touch screen, the button may be a touch sensitive area of the touch screen of the display module 345.

The camera module 350 may pass video or photos to the processor module 320 for forwarding to the user interface module 340 and display on the display module 345. Alternatively, the camera module 350 may pass video or photos directly to the user interface module 340 for display on the display module 345. The processor module 320 may cause the user interface module 340, including the display module 345, to display an alignment aid such as alignment aids 140 and 240 in FIGS. 1A and 2A. The processor module 320 may implement a portion of facial recognition or iris recognition technology sufficient to determine when the camera image from the camera module 350 is favorably aligned with the alignment aid. When the camera image from the camera module 350 is favorably aligned with the alignment aid the processor module 320 may cause the camera module 350 to take a photo.

The camera module 350 may pass video or photos to the processor module 320 for storage in the storage module 330. The processor module 320 may compare the photos or metrics derived from photos to photos or metrics stored in the storage module 330 for the purpose of facial recognition or iris recognition. Alternatively, the processor module 320 may pass photos from the camera module 350 to another computer or device for remote application of facial recognition or iris recognition technology.

Some iris recognition technology works with visible light. Other iris recognition technology works with near infrared light. Having both technologies improves the reliability of iris detection technology. In an example embodiment, the camera module 350 may operate using visible light to take photos. In an example embodiment, the camera module 350 may be capable of taking photos using near infrared light. Some standard digital cameras have the ability for detection of near infrared light, but at a quality less than that of a camera designed for near infrared light. For these cameras, illuminating the subject with near infrared light enhances the camera's ability to take a photo in the near infrared spectrum.

In an example embodiment, the mobile device 300 may have a near infrared light source, such as an led or other light or built into the display module 345, which the processor 320 can cause to illuminate the subject to enhance a photo taken by the camera module 350. In an alternate example embodiment, an external near infrared light source may be attached to the mobile device 300 to achieve the same effect. In example embodiments where near infrared photos are possible, the mobile device 300 may acquire photos using visible light, near infrared light, or both for use in iris recognition.

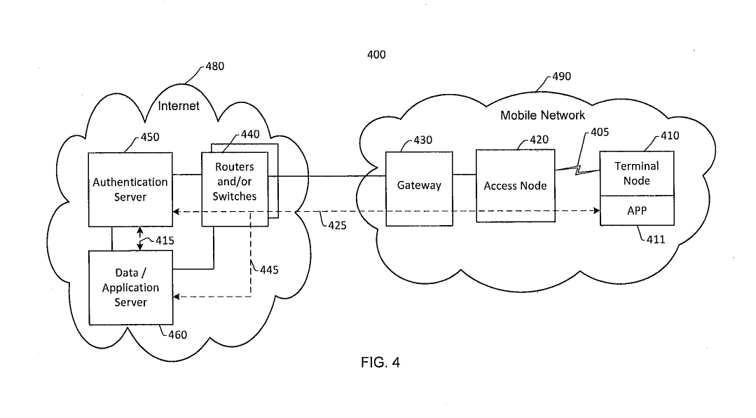

FIG. 4 is a block diagram of a network 400 for performing user identity verification according to an example embodiment. In some scenarios, a terminal node 410, which may be an instance of the mobile device 300 of FIG. 3, may not perform facial recognition or iris recognition locally. This may be due to a number of reasons. The terminal node 410 may not have the processing power or logic locally to be capable of performing these tasks. Alternatively, the terminal node 410 may be capable of performing facial recognition or iris recognition locally, but the database against which to compare may be remote. Alternatively, the terminal node 410 may be capable of performing facial recognition or iris recognition locally, but the application or data access requiring user authentication may have its own algorithms, databases, security domains, etc.

The terminal node 410 accesses the Internet 480 via mobile network 490 which may be for example cellular 2G, 3G, 4G (including LTE, LTE Advanced, and WiMAX), Wi-Fi, Ultra Mobile Broadband (UMB), and other point-to-point or point-to-multipoint wireless technologies. The access node 420, which may be for example, but not limited to, a cellular base station or Wi-Fi AP, provides airlink 405 for communication with terminal node 410. The access node 420 may be connected to the Internet 480 through some number, including zero, of gateways 430 or routers (not shown) or bridges (not shown) that are a part of the mobile network 490 and connect to one or more routers and/or switches 440 or bridges (not shown) in the Internet 480. This connectivity ultimately provides access to an authentication server 450. One skilled in the art would understand that there a numerous network topologies of gateways, routers, switches, and bridges that may provide the path to connect the terminal node 410 with the authentication server 450.

The above mentioned connectivity between the terminal node 410 and the authentication server 450 and data/application server 460 provides a logical connection 425 between APP 411 on the terminal node 410 and the authentication server 450. In an example embodiment the APP 411 may provide the authentication server 450 with a facial image or an image of an iris or two irises or metrics derived from the images via the logical connection 425. Upon successful authentication, the authentication server 450 allows access to the data/application server 460 and the data and/or applications it serves. In an example embodiment, access to the data/application server 460 by the APP 411 may be through the authentication server 450 as shown by the logical connection 415 which is an extension of the logical connection 425. In another example embodiment, after authentication by the authentication server 450, the APP 411 may access the data/application server 460 without a need to go through the authentication server 450 as shown by the logical connection 445.

In an example embodiment the terminal node 410 may perform local facial recognition or iris recognition against a local image or database for device access to the terminal node 410 while the APP 411, resident on the terminal node 410, may engage the authentication server 450 in remote facial recognition or iris recognition to authenticate the user's right to use the APP 411 or access data on the data/application server 460.

In an example embodiment the APP 411 may be replaced by a remote application or webpage on the data/application server 460 which is accessed by the terminal node 410.

In an example embodiment the terminal node 410 may be connected to the Internet 480 via wired technology, such as a corporate local area network (LAN).

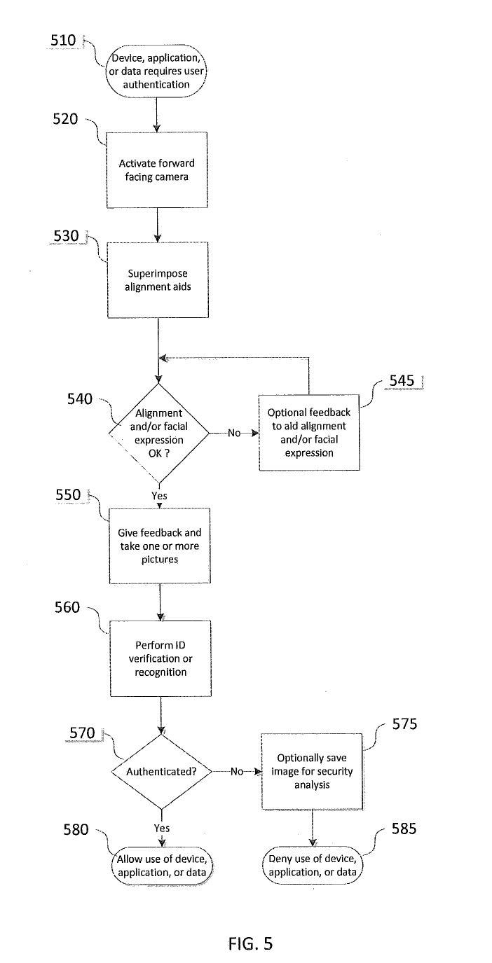

FIG. 5 is a flowchart of a method for operating a device to perform user identity verification according to an example embodiment. Referring to FIG. 5, a determination is made that user authentication is necessary for access to the device, an application, or data (510). The mobile device, such as the mobile device 300 in FIG. 3, enters an identification verification mode. The forward facing camera such as cameras 120 of FIG. 1A or 220 of FIG. 2A, or any camera capable of taking an image of the user, is activated (520). One or more alignment aids such as alignment aid 140 of FIG. 1A or alignment aid 240 of FIG. 2A are overlaid on the display in a position favorable to the detection method in use, i.e., facial recognition or iris recognition (530).

A determination is made as to whether the alignment of the user with the camera is sufficiently favorable for the recognition method (540). If the alignment is not sufficiently favorable (540-N), feedback may be provided to aid in the alignment process (545). For example, an alignment indicator such as the alignment verification 150 of FIG. 1B or the alignment verification 250 of FIG. 2B could blink to indicate lack of alignment. As an alternative to a visual alignment aid, visual alignment indicator or both, instructions, such as “move the camera closer” or “move the camera to the right” may be provided by audio or textual feedback.

In addition to positional alignment, the method may also detect a user's facial expression, i.e., whether the user is smiling or not or whether the user has one or both eyes shut (540). Feedback may include text or audio instructing the user to not smile or to ensure that their eyes are open (545). The method iterates between alignment/facial expression detection (540) and feedback (545) until determines determination is made that the alignment is sufficient. One skilled in the art would understand that facial recognition may not require an alignment aid.

When alignment is adequate, feedback is given, for instance using alignment verification 150 of FIG. 1B or alignment verification 250 of FIG. 2B, indicating proper alignment (540-Y) and one or more pictures are taken (550). The one or more pictures taken are used to perform facial recognition or iris recognition based on pictures or metrics derived from analysis of pictures (560). In an example embodiment, a sound produced when the image is taken, such as a “camera shutter sound” commonly used in digital cameras, may serve as feedback that alignment was sufficient. In an example embodiment, the device may perform the recognition process locally, based upon local pictures or metrics. In an alternate embodiment, the device may interact with an authentication server which performs the actual authentication or verification of identity.

A determination is made as to whether the authentication was successful (570). If successful (570-Y), access is allowed to the device, an application, or data (580). If the authentication is unsuccessful (570-N), the image that failed authentication may be saved for security analysis (575) and access to the device, application, or data is denied (585). The image that failed authentication may be used, for instance, to alert corporate security personnel or other security entity that an unauthorized user tried to access a device, application, or data for which they were not authorized.

Upon successful authentication, the image may be used to further train the recognition system, accounting for gradual changes in appearance, such as aging or changes to hair style. Additionally, in case of failure to authenticate an authorized user, the image may be used to better train the recognition system for future authentication attempts by the authorized user.

Facial recognition and iris recognition systems may be defeated by showing them a photograph rather than a real face or eyes of an intended user. Accordingly, there is an additional need to determine that the image used for recognition is from a live person. In an example embodiment which uses facial recognition, the method may further instructs the user to take a picture first angled towards the right side of the face and subsequently angled towards the left side of the face when determining alignment and/or facial expression (540). The combination of pictures is used to ensure that the images are from a live person, not a previously taken photograph. One or both pictures are used to perform identification verification or recognition (560), which may include 3-dimensional facial recognition.

In an example embodiment which uses facial recognition, the user is instructed to smile and then to refrain from smiling. Smile detection technology can note the difference. The motion of the mouth may be detected as well. In an example embodiment which uses facial recognition or iris recognition, the user may be instructed to close their eyes and then open them. Technology for detecting shut eyes can note the difference. The motion of the eyes may be detected as well. In an example embodiment which uses facial recognition or iris recognition, the user may be instructed to read a text string displayed on the screen. The motion of the eyes can be detected. In an example embodiment which uses facial recognition or iris recognition, the display or another light source may be brightened and then returned to normal or dimmed. This will cause the user's pupils to constrict and dilate. The change can be detected. Any of these techniques may aid in determining that a live person, rather than a photograph, is the subject of identity authentication or verification.

Once access to a device, application, or data has been granted to a user there is a need to prevent access from being passed to an unauthorized user. For example, if an adult is authorized to use a mobile or online gambling device or application, there is a need to prevent access from being subsequently passed to a minor. In an example embodiment, the forward facing camera, such as camera 120 of FIG. 1B, could periodically take images of the current user of a device and re-verify the user's identity. To improve efficiency, even if the initial authentication was performed with interaction with a remote authentication server or database, the re-verification can be against a locally stored copy of verification information, for example, but not limited to, the first image taken in initial authentication or derived metrics used in the recognition algorithm.

Additionally, re-verification can occur when the user is opportunistically aligned so as to not disrupt the user. If a certain time passes, exceeding a timer or threshold, without the occurrence of a sufficient image, the re-verification process may disrupt the user by requiring a suitably aligned image to be taken as described above. If the user re-verification is successful, continued access to the device, application, or data is granted. If the user re-verification fails, continued access to the device, application, or data is denied. In an example embodiment, if re-verification is needed the device may notify the user, for example by emitting a beep or other audible sound. If the user does not attempt re-verification within a specific time, the device may prevent further access and may also logoff the user or power down the device.

In some scenarios, once access to a device, application, or data has been granted to a user there is a need to prevent access from being passed to an unauthorized user, yet there is a simultaneous need to allow access by one or more additional authorized users. For example, a hospital may use a pool of tablet computers to allow doctors and nurses to access patient data. A doctor may go through the authentication method described above to be authenticated to use the device and access a patient's data. However, while interacting with the patient, the doctor may ask a nurse, intern, or other authorized user to take over control of the tablet computer and provide the doctor with patient information. The re-verification process can determine that the user is now different. Rather than immediately denying access to the new user, the new user is authenticated. If the authentication of the new user is successful, continued access to the device, application, or data is granted. If the new user authentication fails, continued access to the device, application, or data is denied.

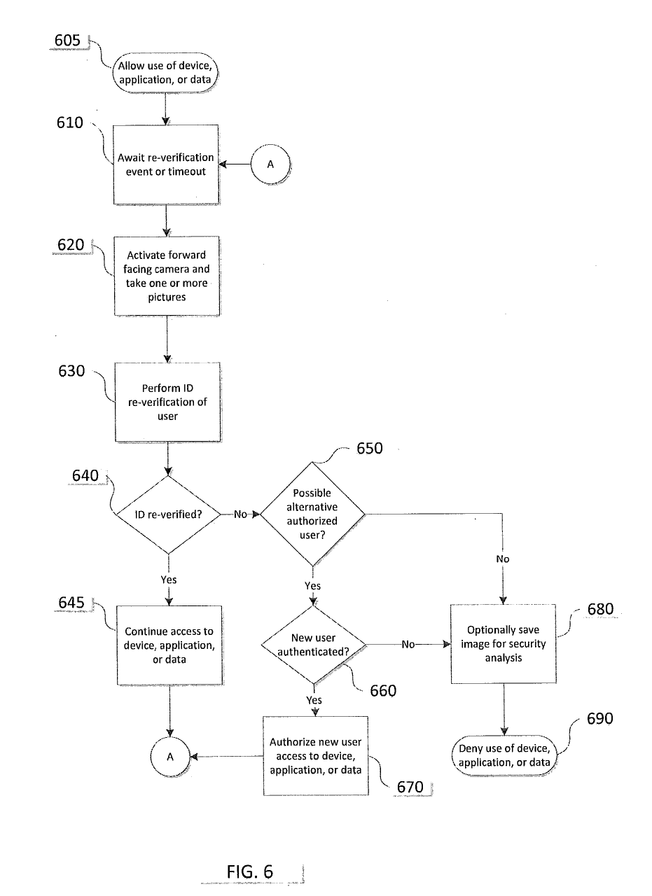

FIG. 6 is a flowchart of a method for operating a device to perform user identity re-verification and re-authentication according to an example embodiment. Referring to FIG. 6, the user is allowed access to the device (605) by some previous means such as the method described with respect to FIG. 5. The method waits for an event indicating a need to re-verify that the original user is still the current user (610). When an appropriate event occurs, such as a timeout, lack of facial detection, or lack of motion of the device, the forward facing camera is activated, if not already activated for other purposes, and one or more images are taken (620). If no face was detected, instructions, for example, but not limited to, audible commands may be provided informing the user of the need to move into view of the camera.

In an example embodiment, alignment aids and alignment feedback may be provided. Referring to FIG. 6, the ID of the user is re-verified (630). In an example embodiment, facial recognition may be used for re-verification due to the lower dependence on proper alignment of the user compared to alignment required for iris detection. This may eliminate the need for alignment aids or indicators unless the user is substantially out of the view of the camera. In an example embodiment, initial user authentication may be performed using iris recognition which is more reliable than facial recognition and subsequent re-verification may be performed using facial recognition which is less disruptive of the user's activities.

In FIG. 6, a determination is made whether the re-verification succeeded or failed (640). If the re-verification of the user's identity succeeded (640-Y), continued access to the device, application, or data is allowed (645) and the method returns to await the need for another re-verification (610). If re-verification of the original user failed (640-N), a determination is made as to whether there may be alternative authorized users (650). If there are alternative authorized users (650-Y), authentication of the new user is attempted (660). In an example embodiment, the authentication process is the similar to that described and illustrated in FIG. 5.

In an example embodiment, the image taken is used to authenticate the new user via facial recognition. If authorization of a different user from a set of authorized users requires more security or robustness than re-verifying the original user, a more robust method, for example reverting to iris recognition rather than using unaligned facial recognition, may be used. If the new user is authenticated (660-Y), the new user is allowed access to the device, application, or data (670) and the method returns to await the need for another re-verification (610).

If it is determined that there are no alternative authorized users (650-N), or if authentication of the alternate user fails (660-N), any images may be retained for security analysis (680), and access to the device, application, or data is denied (690).

There is a need to detect whether a device is still in use and restrict access to the device, application, or data while the device is not in use and to re-verify or re-authenticate a user prior to continued access. Many mobile devices have accelerometers and gyroscopes. For example, the Apple iPhone 4 smartphone incorporates the ST Microelectronics LIS331DLH 3-axis accelerometer and the ST Microelectronics L3G4200D 3-axis gyroscope. The combination of the two elements provides the ability to detect how far, how fast, and in what direction the device is moving. Referring to FIG. 3, the mobile device 300 may include a motion detection module 360 which detects device motion and orientation. Device motion and orientation sensing are well known in the art and will not be described here further. For a device with motion sensing, it is possible to detect a lack of motion, for example, if the user lays down the device. A device with orientation sensing allows detection of a device in a horizontal orientation, for instance, when it is placed on a desk or table. When a horizontal orientation and/or a lack of motion is detected, the device may activate the front facing camera. Alternatively, continued use of the device may be determined by detecting keypad presses and/or touch screen selections, and the device may activate the front facing camera. Using facial detection or facial recognition, it can be determined that someone is still using the device or re-verify that the originally authenticated user is using the device.

If no user or no authorized user is present a number of actions may be taken. The device may darken the screen to prevent unauthorized viewing of data, for example, patient data, until the device is moved, an action is taken on the user interface, or a user is re-authorized. The device may immediately go into a mode where user authentication is required or may do so after a first timeout. After a second timeout period, the device may send an alert to an entity responsible for device security. After a third timeout period, the device may log off the user or power off. One of ordinary skill in the art will appreciate that the timeout periods may be within a range of several seconds to several minutes.

Those of ordinary skill in the art will appreciate that the various illustrative logical blocks, modules, controllers, units, and algorithms described in connection with the embodiments disclosed herein can often be implemented as electronic hardware, computer software, or combinations of both. To clearly illustrate this interchangeability of hardware and software, various illustrative components, units, blocks, modules, and operations have been described above generally in terms of their functionality. Whether such functionality is implemented as hardware or software depends upon the particular system and design constraints imposed on the overall system. Persons of ordinary skill in the art can implement the described functionality in varying ways for each particular system, but such implementation decisions should not be interpreted as causing a departure from the scope of the invention. In addition, the grouping of functions within a unit, module, block or operation is for ease of description. Specific functions or operations can be moved from one unit, module or block without departing from the invention. Electronic content may include, for example, but not limited to, data and/or applications which may be accessed through the mobile device.

The various illustrative logical blocks, units, operations and modules described in connection with the example embodiments disclosed herein may be implemented or performed with, for example, but not limited to, a processor, such as a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be, for example, but not limited to, a microprocessor, but in the alternative, the processor may be any processor, controller, or microcontroller. A processor may also be implemented as a combination of computing devices, for example, but not limited to, a combination of a DSP and a microprocessor, a plurality of microprocessors, one or more microprocessors in conjunction with a DSP core, or any other such configuration.

The operations of a method or algorithm and the processes of a block or module described in connection with the example embodiments disclosed herein may be embodied directly in hardware, in a software module (or unit) executed by a processor, or in a combination of the two. A software module may reside in, for example, but not limited to, random access memory (RAM), flash memory, read-only memory (ROM), erasable programmable read only memory (EPROM), electrically erasable programmable read only memory (EEPROM), registers, hard disk, a removable disk, a compact disk (CD-ROM), or any other form of machine or non-transitory computer readable storage medium. An exemplary storage medium may be coupled to the processor such that the processor can read information from, and write information to, the storage medium. In the alternative, the storage medium may be integral to the processor. The processor and the storage medium may reside in an ASIC.

The above description of the disclosed example embodiments is provided to enable any person of ordinary skill in the art to make or use the invention. Various modifications to these example embodiments will be readily apparent to those skilled in the art, and the generic principles described herein can be applied to other embodiments without departing from the spirit or scope of the invention. Thus, it is to be understood that the description and drawings presented herein represent example embodiments of the invention and are therefore representative of the subject matter, which is broadly contemplated by the present invention. It is further understood that the scope of the present invention fully encompasses other embodiments that may become obvious to those skilled in the art.

What is claimed is:

1. A method of capturing a photograph of a user's face with a mobile device, the method comprising:
determining alignment of an image of the user's face with a camera of the mobile device;
providing one of a visual indicator and an audible sound as an alignment verification aid which indicates to the user when facial alignment is favorable; and
taking a photograph of the user's face when alignment of the user's face with the camera is favorable.

2. The method of claim 1, wherein the alignment verification aid changes from a first state to a second state when the user's face is favorably aligned.

3. The method of claim 1, further comprising providing at least one of audible and textual instructions which direct the user to move the camera to achieve favorable alignment of the user's face with the camera.

4. The method of claim 1, wherein the photograph of the user's face is taken automatically when alignment of the user's face with the camera is favorable.

5. The method of claim 4, wherein a plurality of photographs are automatically taken prior to a final photograph automatically taken at favorable alignment.

6. The method of claim 5, further comprising performing three-dimensional (3D) facial recognition based on the plurality of photographs and the final photograph.

7. The method of claim 1, further comprising detecting motion of the user's eyes prior to taking the photograph of the user's face.

8. The method of claim 1, further comprising detecting constriction and dilation of the user's pupils when a light source is brightened and then dimmed prior to taking the photograph of the user's face.

9. The method of claim 1, further comprising detecting whether the user's face is smiling or whether the user's eyes are open and providing a smile or eyes open indication to the user via the alignment verification aid.

10. The method of claim 9, wherein the alignment verification aid changes from a first state to a second state when it is detected that the user is not smiling or the user's eyes are open.

11. The method of claim 10, wherein the photograph of the user's face is taken automatically when it is detected that the user is not smiling or the user's eyes are open.

12. The method of claim 9, further comprising providing at least one of audible and textual instructions which direct the user to refrain from smiling or to open the eyes.

13. The method of claim 9, further comprising providing at least one of audible and textual instructions which direct the user to smile and then to refrain from smiling or to close the eyes and then to open them.

14. The method of claim 1, further comprising performing facial recognition on the captured photograph of the user's face.

15. The method of claim 1, wherein a first photograph of the user's face is taken at a first facial alignment and a second photograph of the user's face is taken at a second facial alignment different from the first facial alignment.

16. The method of claim 15, further comprising providing at least one of audible and textual instructions directing the user to position the camera for the first facial alignment and for the second facial alignment.

17. The method of claim 15, wherein the first facial alignment is one eye and nose in profile and the second facial alignment is the other eye and nose in profile.

18. The method of claim 17, further comprising performing three-dimensional (3D) facial recognition based on the first and second photographs of the user's face.

19. A method of capturing an image of a user's iris with a mobile device, the method comprising:
determining alignment of an image of the user's eye with a camera of the mobile device;
providing one of a visual indicator and an audible sound as an alignment verification aid which indicates to the user when eye alignment is favorable; and
capturing an image of the user's iris when alignment of the user's eye with the camera is favorable.

20. The method of claim 19, wherein the alignment verification aid changes from a first state to a second state when the user's eye is favorably aligned.

21. The method of claim 19, further comprising providing at least one of audible and textual instructions which direct the user to move the camera to achieve favorable alignment of the user's eye with the camera.

22. The method of claim 19, wherein the iris image is captured automatically when alignment of the user's eye with the camera is favorable.

23. The method of claim 19, further comprising detecting motion of the user's eyes prior to capturing the image of the user's iris.

24. The method of claim 19, further comprising detecting constriction and dilation of the user's pupils when a light source is brightened and then dimmed prior to capturing the image of the user's iris.

25. The method of claim 19, further comprising detecting whether the user's eye is open and providing an eye open indication to the user via the alignment verification aid.

26. The method of claim 25, wherein the alignment verification aid changes from a first state to a second state when it is detected that the user's eye is open.

27. The method of claim 26, wherein the image is captured automatically when it is detected that the user's eye is open.

28. The method of claim 25, further comprising providing at least one of audible and textual instructions which direct the user to open the eyes.

29. The method of claim 25, further comprising providing at least one of audible and textual instructions which direct the user to close the eyes and then to open them.

30. The method of claim 19, further comprising performing iris recognition on the captured iris image.

31. The method of claim 19, wherein the user's iris is illuminated with visible light.

32. The method of claim 19, wherein the user's iris is illuminated with near infrared light.

33. The method of claim 19, wherein the user's iris is illuminated with both visible light and near infrared light.

34. A method of granting or denying access, the method comprising:
capturing an image of a user's face when alignment of the user's face with a camera of a mobile device is favorable;
performing facial recognition on the captured image;
determining if the user is authenticated as an authorized user based on facial recognition results;
when the user is authenticated as an authorized user, permitting access; and
when the user is determined to be an unauthorized user, denying access and storing the captured image of the unauthorized user.

35. The method of claim 34, wherein an authorized user is permitted access to at least one of an application and data available through the mobile device.

36. The method of claim 35 wherein the authorized user is a member of a group of authorized users permitted access to the at least one of an application and data available through the mobile device.

37. The method of claim 34, wherein a security analysis is performed on the stored image of the unauthorized user.

38. The method of claim 34, wherein the captured image is used to train the facial recognition system.

39. The method of claim 34, further comprising re-verifying the identity of the authorized user after access is permitted by periodically capturing images of a current user and performing facial recognition to authenticate the current user.

40. The method of claim 39, wherein re-verification of the authorized user is performed based on verification information stored on the mobile device.

41. The method of claim 39, wherein re-verification of the authorized user is performed when the current user is opportunistically aligned with the camera without interrupting the current user.

42. The method of claim 39, wherein re-verification of the authorized user is performed after a predetermined period of time by interrupting the current user and requiring capture of a favorably aligned facial image.

43. The method of claim 39, wherein when the current user is not authenticated as the authorized user, determining if the current user is authenticated as another authorized user based on facial recognition results; and
when the current user is authenticated as an authorized user, permitting access, and when the current user is not authenticated as an authorized user, denying access.

44. The method of claim 39, wherein when one of a lack of device motion and horizontal orientation of the mobile device is detected for a predetermined period of time, the camera is activated, and when no face is detected, instructions are provided to the current user to move into view of the camera.

45. The method of claim 44, further comprising when no user or no authorized user is present a display screen of the mobile device is darkened until an action is taken to resume access.

46. The method of claim 45, wherein the action to resume access is one of moving the mobile device, performing on operation on a user interface of the mobile device, and re-verifying an authorized user of the mobile device.

47. The method of claim 44, further comprising when no user or no authorized user is present the mobile device enters a mode requiring user authentication to resume access.

48. The method of claim 47, wherein the mobile device immediately enters a mode requiring user authentication to resume access.

49. The method of claim 47, wherein after a first timeout period the mobile device enters a mode requiring user authentication to resume access.

50. The method of claim 49, wherein after a second timeout period the mobile device sends an alert to an entity responsible for security of the mobile device.

51. The method of claim 50, wherein after a third timeout period the mobile device either logs off the previously authorized user or powers off.

52. A method of granting or denying access, the method comprising:
capturing an image of a user's iris when alignment of the user's eye with a camera of a mobile device is favorable;
performing iris recognition on the captured image;
determining if the user is authenticated as an authorized user based on iris recognition results;
when the user is authenticated as an authorized user, permitting access; and
when the user is determined to be an unauthorized user, denying access and storing the captured image of the unauthorized user.

53. The method of claim 52, wherein an authorized user is permitted access to at least one of an application and data available through the mobile device.

54. The method of claim 53 wherein the authorized user is a member of a group of authorized users permitted access to the at least one of an application and data available through the mobile device.

55. The method of claim 52, further comprising re-verifying the identity of the authorized user after access is permitted by periodically capturing facial images of a current user and performing facial recognition to authenticate the current user.

56. The method of claim 55, wherein re-verification of the authorized user is performed based on verification information stored on the mobile device.

57. The method of claim 55, wherein re-verification of the authorized user is performed when the current user is opportunistically aligned with the camera without interrupting the user.

58. The method of claim 55, wherein re-verification of the user is performed after a predetermined period of time by interrupting the current user and requiring capture of a favorably aligned facial image.

59. The method of claim 55, wherein when one of a lack of device motion and horizontal orientation of the mobile device is detected for a predetermined period of time, the camera is activated and when no face is detected, instructions are provided to the current user to move into view of the camera.

60. The method of claim 59, further comprising when no user or no authorized user is present a display screen of the mobile device is darkened until an action is taken to resume access.

61. The method of claim 60, wherein the action to resume access is one of moving the mobile device, performing on operation on a user interface of the mobile device, and re-verifying an authorized user of the mobile device.

62. The method of claim 59, further comprising when no user or no authorized user is present the mobile device enters a mode requiring user authentication to resume access.

63. The method of claim 62, wherein the mobile device immediately enters a mode requiring user authentication to resume access.

64. The method of claim 59, wherein after a first timeout period the mobile device enters a mode requiring user authentication to resume access.

65. The method of claim 64, wherein after a second timeout period the mobile device sends an alert to an entity responsible for security of the mobile device.

66. The method of claim 65, wherein after a third timeout period the mobile device either logs off the previously authorized user or powers off.

67. A mobile device for performing user identity verification, the mobile device comprising:
a display module which displays visual information;
a camera module configured to capture and communicate images; and
a processor module communicatively coupled to the camera module and the display module,
wherein the processor module receives one or more images of a user captured by the camera module and determines, based on the captured one or more images, whether the captured one or more images correspond to an image of an authorized user, and
when the processor module determines the captured one or more images correspond to an image of an authorized user, the processor module permits the user access to one or more of the mobile device, an application available through the mobile device, and data available through the mobile device.

68. The mobile device of claim 67, wherein the processor module processes the captured one or more images and determines whether the captured one or more images corresponds to an image of an authorized user.

69. The mobile device of claim 67, wherein the processor module processes the captured one or more images and determines by communicating with an authentication server whether the captured one or more images corresponds to an image of an authorized user.

70. The mobile device of claim 67, wherein the processor module determines whether the captured one or more images corresponds to an image of an authorized user includes deriving predefined metrics from the captured one or more images and comparing those metrics to the metrics of an image of an authorized user.

71. The mobile device of claim 67, wherein the camera module communicates moving images of a user that are displayed on the display module, and
the processor module is configured to cause the display module to display at least one alignment template to align a facial feature of a user with the camera module.

72. The mobile device of claim 71, wherein the processor module is configured to cause the camera module to capture a user image when the user facial feature is aligned with the alignment template.

73. The mobile device of claim 67, wherein the captured one or more images and the image of an authorized user are iris images.

74. The mobile device of claim 73, further comprising a visible light source and a near infrared light source configured to illuminate the iris of the user.

75. The mobile device of claim 67, wherein when the determination result indicates that the captured one or more images or predetermined metrics derived from the captured one or more images do not correspond to an image of an authorized user or predetermined metrics derived from the image of an authorized user, access to use the mobile device is denied and the captured image is stored for subsequent security analysis.

76. The mobile device of claim 67, wherein when the determination result indicates that the captured one or more images or predetermined metrics derived from the captured one or more images do not correspond to an image of an authorized user or predetermined metrics derived from the image of an authorized user, access to an application available through the mobile device is denied and the captured image is stored for subsequent security analysis.

77. The mobile device of claim 67, wherein when the determination result indicates that the captured one or more images or predetermined metrics derived from the captured one or more images do not correspond to an image of an authorized user or predetermined metrics derived from the image of an authorized user, access to data available through the mobile device is denied and the captured image is stored for subsequent security analysis.

78. A system for performing user identity verification, the system comprising:
a display module which displays visual information;
a camera module configured to capture and communicate images;
a transmitter/receiver module which communicates with a remote server; and
a processor module communicatively coupled to the display module, the camera module, and the transmitter/receiver module,
wherein the processor module receives one or more images of a user captured by the camera module and derives predetermined metrics from the captured one or more images, the processor module communicates the received one or more captured images to the transmitter/receiver module,
the transmitter/receiver module transmits the one or more captured images or the predetermined metrics derived from the captured one or more images to a remote server,
the transmitter/receiver module receives a determination, based on the captured one or more images or predetermined metrics derived from the captured one or more images, whether the captured one or more images or predetermined metrics derived from the captured one or more images correspond to an image of an authorized user or predetermined metrics derived from an image of an authorized user,
the transmitter/receiver module communicates the determination result to the processor module, and
when the determination result indicates that the captured one or more images or predetermined metrics derived from the captured one or more images correspond to an image of an authorized user or the predetermined metrics derived from an image of an authorized user, the processor module permits the user access to one or more of a mobile device, an application available through the mobile device, and data available through the mobile device.

79. The system of claim 78, wherein images of authorized users or predetermined metrics derived from the images of authorized users are stored remotely from the system.
